(19) United States
(12) Patent Application Publication
(10) Pub. No.: US 2009/0261631 A1
(43) Pub. Date: Oct. 22, 2009

(54) Child Carriage Tray and support therefor

(76) Inventor: Quy My Early, Parkinson (AU)

Correspondence Address: Quy Early, 33 Clifton Place, Parkinson, Queensland, 4115, omitted

(21) Appl. No.: 11/924,605

(22) Filed: Apr. 21, 2008

(51) Int. Cl. B62B 9/12

(52) U.S. Cl. 297/148

(57) ABSTRACT

A child carriage tray and support therefor including: a tray having an upper face and a lower face opposed to the upper face and a pair of strut assembles each mountable to the lower face in a selectable spaced relationship one to the other by mounting means formed into or with each strut assembly and formed for detachable mounting to one of a plurality of sets of complementary mounting means on the lower face of the tray, each set of complementary mounting means incorporating two pivot locations in spaced relationship formed therein or therewith, each strut assembly comprising: a minor strut having a portion of the mounting means formed on or with an end for mounting to one of the pivot locations on the lower face by one the end; a major strut having another or the remaining portion of the mounting means formed on or with and end for mounting to the other of the pivot locations on lower face by the end and having adjustable engagement means for engaging the other end of the minor strut a one of a plurality of engagement locations intermediate the ends of the major strut whereby the major strut may be fixed at one of a variety of angles with the top chord, and the major strut further having attachment means operatively associated with the other of its ends for attaching the major strut to a frame member of a child carriage.

### FIELD OF INVENTION

THIS INVENTION relates to child carriage tray and a support for a tray for use on child carriages. The invention has particular application to tray and support therefor which may be mounted to a variety of models of child carriage.

### BACKGROUND ART

Child carriages can be in the form of perambulators (prams), strollers and such like. In this specification, the term “child carriages” refers to carriages for children which are typically pushed by hand by a human pedestrian, such as parent or other adult carer, unless the context requires otherwise.

Child carriages sometimes come with a tray mounted for use by or convenience of the child being carried. However, many such child carriages do not have such a feature. Although there is a wide variation in the configuration of child carriages, some of the more fundamental dimensions vary within relatively narrow bands. Even so, a tray designed for and/or mounted to one brand or style of child carriage will usually not be mountable to other brands or styles of child carriage. Most child carriages are constructed from a frame having frame members of tubular form.

The present invention aims to provide a tray and support therefor which addresses the shortcomings of the prior art. The invention also aims to provide tray and support therefor which may be mounted to a variety of different brands or models of child carriage. Other aims and advantages of the invention may become apparent from the following description.

### DISCLOSURE OF THE INVENTION

With the foregoing in view the invention in one aspect resides broadly in a child carriage tray and support therefor including:

a tray having an upper face and a lower face opposed to the upper face and a pair of strut assembles each mountable to the lower face in a selectable spaced relationship one to the other by mounting means formed into or with each strut assembly and formed for detachable mounting to one of a plurality of sets of complementary mounting means on the lower face of the tray, each set of complementary mounting means incorporating two pivot locations in spaced relationship formed therein or therewith, each strut assembly comprising:
a minor strut having a portion of said mounting means formed on or with an end for mounting to one of said pivot locations on said lower face by one said end;
a major strut having another or the remaining portion of said mounting means formed on or with and end for mounting to the other of said pivot locations on lower face by said end and having adjustable engagement means for engaging the other end of said minor strut a one of a plurality of engagement locations intermediate the ends of the major strut whereby said major strut may be fixed at one of a variety of angles with said top chord, and said major strut further having attachment means operatively associated with the other of its ends for attaching said major strut to a frame member of a child carriage.

Preferably, a top chord is interposed between the lower face of the tray and the pivotal connections of the major and minor struts thereto, the pivot locations of the complementary mounting means being provided in spaced relationship formed on or with the top chord and said mounting means also formed therein or therewith.

In another aspect, the invention resides broadly in a child carriage tray and support therefor including:

a tray having an upper face and a lower face opposed to the upper face and a pair of strut assembles each mountable to the lower face in a selectable spaced relationship one to the other by mounting means formed into or with each strut assembly formed for detachable mounting to one of a plurality of sets of complementary mounting means on the lower face of the tray, each strut assembly comprising:
a top chord having said mounting means formed therein or therewith and two pivot locations in spaced relationship formed therein or therewith;
a minor strut mounted to one of said pivot locations on said top chord by one of the ends of the minor strut;
a major strut mounted to the other of said pivot locations on said top chord by one of the ends of the major strut and having adjustable engagement means for engaging the other end of said minor strut a one of a plurality of engagement locations intermediate the ends of the major strut whereby said major strut may be fixed at one of a variety of angles with said top chord, and said major strut further having attachment means operatively associated with the other of its ends for attaching said major strut to a frame member of a child carriage at a predetermined angle of said major strut to the frame member.

The selection of the angle of the major strut to the top chord or lower face of the tray provides a selection of angles of the tray to the frame member of the child carriage, and the plurality of sets of complementary mounting means provides a selection of spacings of the strut assemblies. Accordingly, the carriage tray and support therefor may be attached to a variety of child carriages having their respective frame members arranged at different angles and spacings from one another.

### BRIEF DESCRIPTION OF THE DRAWINGS

In order that the invention may be more easily understood and put into practical effect, reference will now be made to the accompanying drawings which illustrate a preferred embodiment of the invention and wherein:

FIG. 1 is a pictorial view looking towards the underside of a child carriage tray and support therefor (hereinafter referred to as a “tray assembly”) according to the invention;

FIG. 2 is a pictorial view looking towards underside of the tray assembly of FIG. 1 but from a different viewing angle;

FIG. 3 is a pictorial view looking towards underside of the tray assembly of FIG. 1 but from a different viewing angle from that of FIGS. 1 and 2;

FIG. 4 is a pictorial view looking towards the upper side of the tray assembly of FIG. 1;

FIG. 5 is a pictorial view of the major strut of a strut assembly for the tray assembly of FIGS. 1 to 4;

FIGS. 6 and 7 are a side view and a front view of the major strut of FIG. 5;

FIGS. 8, 9 and 10 are frontal views of three clamp assembly inserts for clamping about small, medium and large diameter frame members of a child's carriage;

FIG. 11 is a sectional view of the end portion of the major strut of FIGS. 5 to 7;

FIGS. 12 and 13 show in pictorial view and in end view a clamp latch for the tray assembly of FIGS. 1 to 4;

FIGS. 14 and 15 show in pictorial and end view a clamp doglet for the tray assembly of FIGS. 1 to 4;

FIGS. 16 to 19 show in end, side, front and pictorial view a minor strut for the tray assembly of FIGS. 1 to 4; and

FIGS. 20 to 22 show in front, side and end elevation a top cord for the strut assembly of FIGS. 1 to 4.

### DETAILED DESCRIPTION OF THE DRAWINGS

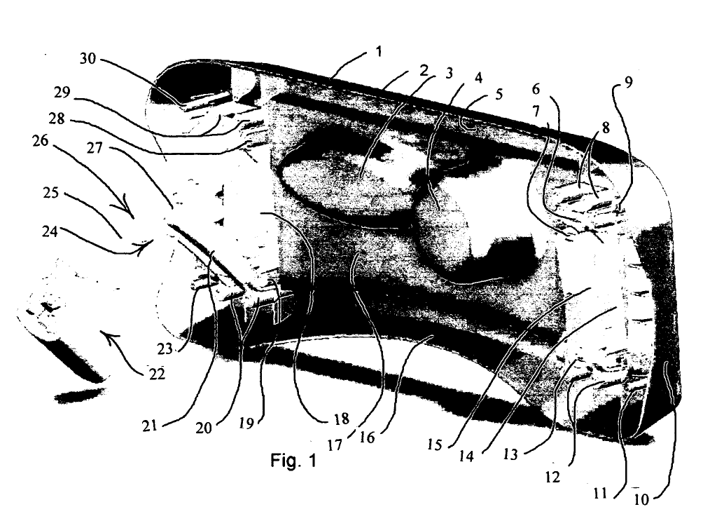

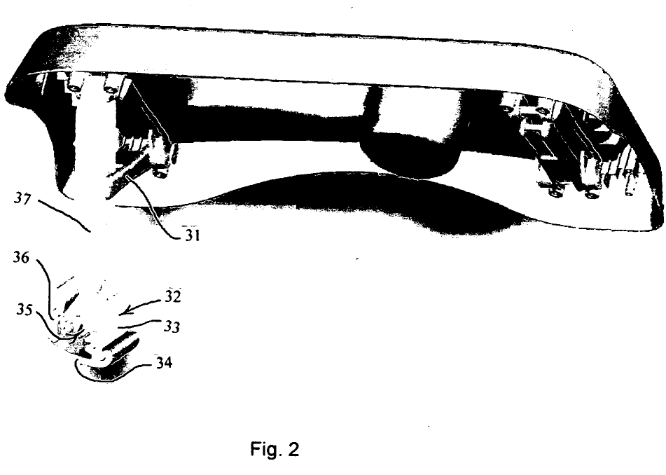

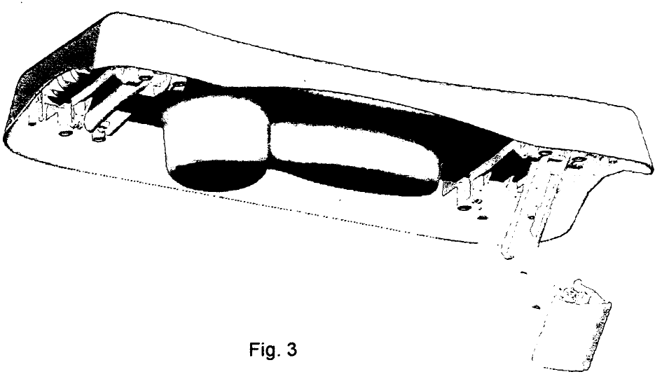

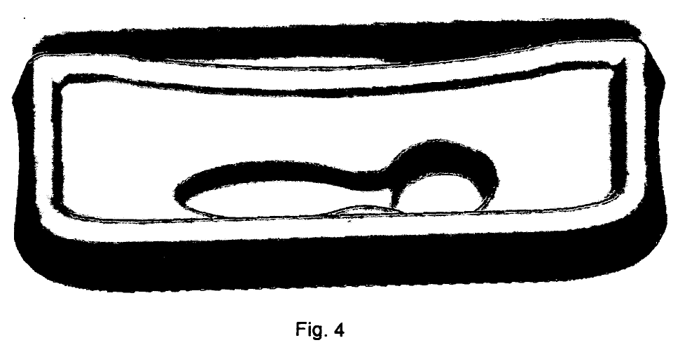

The child carriage tray and support therefor 10 shown in FIGS. 1 to 4 is shown in several orientations, and accordingly, not all of the elements of the tray are shown in each drawing. For clarity, some of the reference numerals used in respect of FIGS. 1 and 2 are not repeated in FIGS. 3 and 4. The various parts and components of the tray assembly are shown in FIGS. 5 to 21, and reference numerals used in respect of the tray assembly are provided relevantly to the detail thereof, but the reference numerals are not provided for each instance of those features in all Figs.

The child carriage tray and support therefore (hereinafter referred to as “tray assembly”) 10 includes a tray top 11 and two strut assemblies 20 attached to the under side of the tray top. For clarity in showing other elements of the strut assembly, only one of the strut assemblies is shown in full. The tray top has a skirt surrounding its edge comprising a substantially straight front edge 12, two substantially straight side edges 13 extending from each end of the front edge through respective curved corners and a rear edge 14 connecting the other ends of the side edges, again extending from curved corners. The rear edge includes a concave curvature towards the front edge. The tray top also has a substantially flat tray area 15 surrounded by a raised edge 18 from which the skirt depends. An elongate depression 16 is provided spaced in from the front edge of the tray area and leads into a circular depression 17 which is somewhat deeper than the elongate depression. The elongate depression is in the form of an elliptical section depression, the elongate and circular depressions having substantially flat bases. The front and rear edges of the tray top are somewhat longer than the side edges to give the tray assembly an elongate form between the strut assemblies substantially parallel to the side edges and each other.

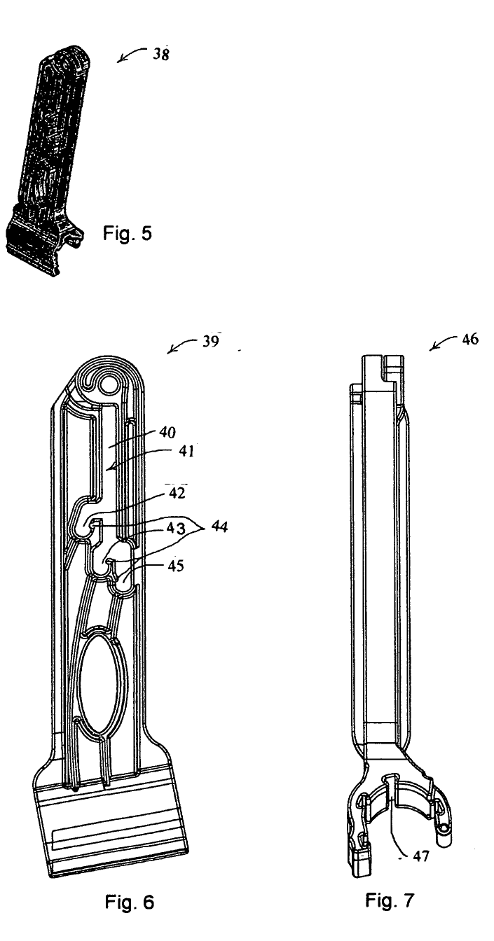

The strut assembly includes a top cord 21 of elongate form attachable to complementary mounting pins shown typically at 25 by way of mounting sockets 24. A major strut 22 is pivotally attached to a front pivot 27 of the top cord. A minor strut 23 is pivotally connected to a rear pivot 26 of the top cord for adjustable engagement with the major strut at 28. The minor strut engages with the major strut by way of an engagement aperture 30, the details of which are shown in FIG. 6.

The engagement aperture of the major strut is shown in more detail in FIGS. 5 to 7. The major strut includes a substantially straight slot portion 31 and first, second and third strut positions 32, 33 and 34 diverging from the slot portion. Each strut position includes a locking lug 35 protruding some distance into the slot, the slot portion and strut positions having substantially the same transverse dimensions except where the locking lug protrudes thereinto so that an adjustable engagement axle 38 at one end of the minor strut can engage in the slot for movement therealong into any one of the three strut positions, and be locked therein by urging the axle through the pinch between the locking lug and the opposite face of the strut position. Each of the strut positions is at a different distance from the end of the major strut to provide for the major and minor struts to be secured at any one of three angles to the top chord and tray top.

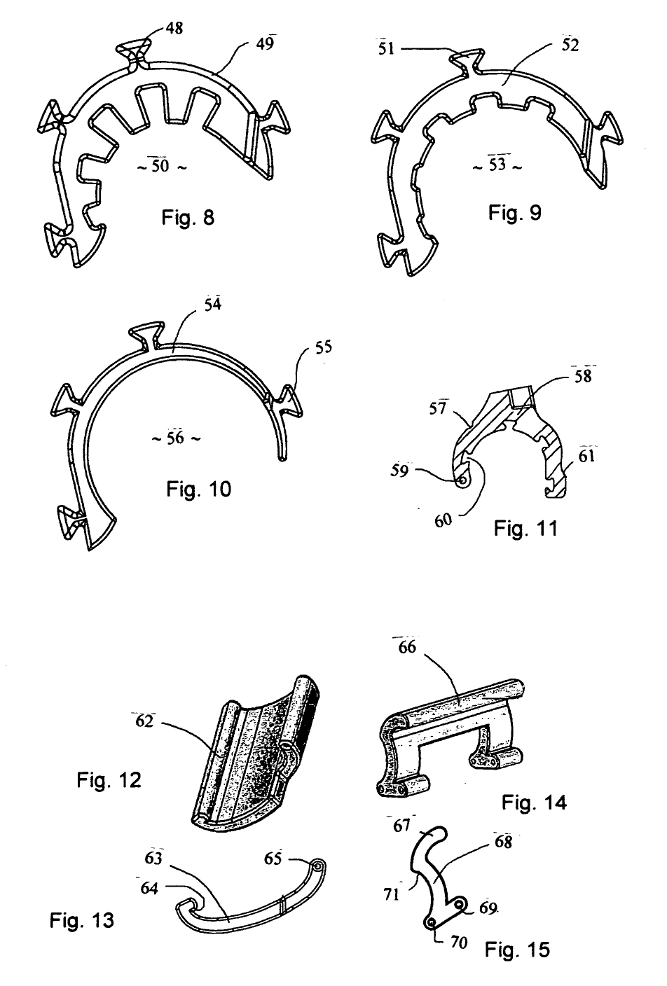

The clamp inserts 44A, 44B & 44C shown in FIGS. 8, 9 and 10 are provided with four splines shown typically at 46 for engagement with respective clamp slots shown typically at 45 in FIGS. 7 & 11. Each clamp insert is of a C-section form with a jaw formation 47A, 47B & 47C for respectively accommodating small, medium and larger diameter tubes forming the frame of a child carriage. For the smaller and intermediate size frames for the clamp inserts 44A and 44B, the inserts include elongate ridges and grooves extending coaxially with the C-section to enable flexure of the clamp insert with the clamp body of the major strut. The clamp assembly is shown with reference numerals particularly in FIG. 2 and has a clamp body 41, clamp latch 42, clamp doglet 43 and clamp insert 44, the clamp latch being engaged with a latch anchor 53 on the clamp body, and the doglet having a doglet hook 53 for engagement with a doglet locking groove 54 on the clamp body. The doglet is pivoted by a body pivot 48 to the clamp body at a corresponding clamp pivot 55. The clamp latch is pivotally connected by way of a doglet pivot to the doglet at a latch pivot 49. The doglet includes a handle portion 56 to allow a user to snap the doglet onto the body portion of the clamp assembly as well as to detach the clamp from a frame member of a child carriage to which the tray assembly has been mounted.

The clamp inserts are typically formed from a resilient material such as elastomer or such like. The remainder of the tray assembly would typically be formed from ridged material, preferably a plastics material.

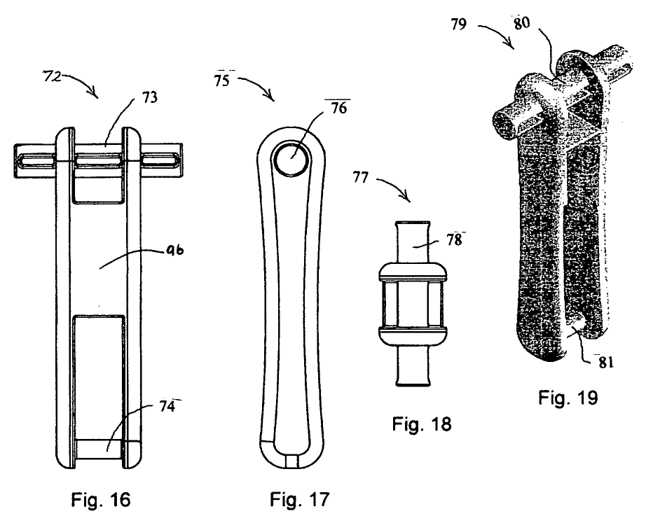

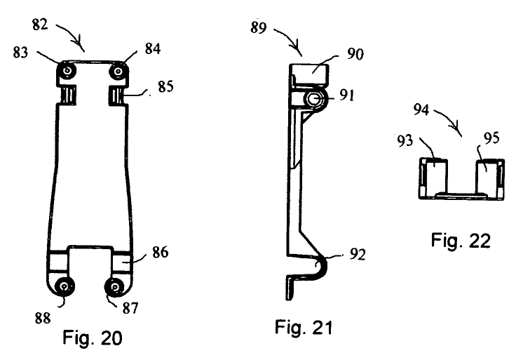

The minor strut is shown in more detail in FIGS. 16 to 19 where is can be seen to include two side portions 57 and a web portion 58 extending therebetween, but only part way along its length. The rear pivot axle extends beyond the side portions but the adjustable engagement axle extends between the side plates. The top chord is shown in more detail in FIGS. 20 to 22 wherein it can be seen that the mounting sockets are provided near the corners, but the spacing of the mounting sockets is greater at the end near the front pivot than the rear pivot, the front and rear pivots interposed between the mounting sockets.

The foregoing description has been given by way of illustrative example of the invention and any such modifications and variations which will be apparent to persons skilled in the art may be made to the example without departing from the spirit and scope of the invention as defined by the following claims.

1. A child carriage tray and support therefor including:
a tray having an upper face and a lower face opposed to the upper face and a pair of strut assembles each mountable to the lower face in a selectable spaced relationship one to the other by mounting means formed into or with each strut assembly and formed for detachable mounting to one of a plurality of sets of complementary mounting means on the lower face of the tray, each set of complementary mounting means incorporating two pivot locations in spaced relationship formed therein or therewith, each strut assembly comprising:
a minor strut having a portion of said mounting means formed on or with an end for mounting to one of said pivot locations on said lower face by one said end;
a major strut having another or the remaining portion of said mounting means formed on or with and end for mounting to the other of said pivot locations on lower face by said end and having adjustable engagement means for engaging the other end of said minor strut a one of a plurality of engagement locations intermediate the ends of the major strut whereby said major strut may be fixed at one of a variety of angles with said top chord, and said major strut further having attachment means operatively associated with the other of its ends for attaching said major strut to a frame member of a child carriage.

2. A child carriage tray and support therefor according to claim 1, wherein a top chord is interposed between the lower face of the tray and the pivotal connections of the major and minor struts thereto, the pivot locations of the complementary mounting means being provided in spaced relationship formed on or with the top chord and said mounting means also formed therein or therewith.

3. A child carriage tray and support therefor including:
a tray having an upper face and a lower face opposed to the upper face and a pair of strut assembles each mountable to the lower face in a selectable spaced relationship one to the other by mounting means formed into or with each strut assembly formed for detachable mounting to one of a plurality of sets of complementary mounting means on the lower face of the tray, each strut assembly comprising:
a top chord having said mounting means formed therein or therewith and two pivot locations in spaced relationship formed therein or therewith;
a minor strut mounted to one of said pivot locations on said top chord by one of the ends of the minor strut;
a major strut mounted to the other of said pivot locations on said top chord by one of the ends of the major strut and having adjustable engagement means for engaging the other end of said minor strut a one of a plurality of engagement locations intermediate the ends of the major strut whereby said major strut may be fixed at one of a variety of angles with said top chord, and said major strut further having attachment means operatively associated with the other of its ends for attaching said major strut to a frame member of a child carriage at a predetermined angle of said major strut to the frame member.

4. A child carriage tray and support therefor according to claim 1 or claim 3, wherein the selection of the angle of the major strut to the top chord or lower face of the tray provides a selection of discrete angles of the tray to the frame member of the child carriage.

5. A child carriage tray and support therefor according to claim 1 or claim 3, wherein the plurality of sets of complementary mounting means provides a selection of spacings of the strut assemblies
